(19) United States
(12) Patent Application Publication
(10) Pub. No.: US 2015/0032842 A1
(43) Pub. Date: Jan. 29, 2015

(54) WEB PAGE PROVISION METHOD AND SYSTEM ASSOCIATED WITH A TWO-DIMENSIONAL BARCODE

(71) Applicants: Norman CHENG, EL Monte, CA (US); Hwey-Chyi LEE, Tainan (TW)

(72) Inventors: Norman CHENG, EL Monte, CA (US); Hwey-Chyi LEE, Tainan (TW)

(21) Appl. No.: 13/951,609

(22) Filed: Jul. 26, 2013

(51) Int. Cl. H04L 29/08

(52) U.S. Cl. CPC H04L 67/02
USPC 709/217

(57) ABSTRACT

In a web page provision method and system, a user terminal transmits to a server service data and a barcode generation request associated with the service data. The server generates a service web page corresponding to the service data, and a web address of the service web page. The server generates a web address alias based on the web address and at least one alternative web address at which a specific web page is located in response to the barcode generation request from the user terminal. The server generates a two-dimensional barcode corresponding to the web address alias.

### BACKGROUND OF THE INVENTION

1. Field of the Invention

The invention relates to a web page provision method and system, and more particularly to a web page provision method and system associated with a two-dimensional barcode.

2. Description of the Related Art

In recent years, two-dimensional barcodes have been widely used to record texts, image information or web addresses. With the popularity of mobile devices, applications of two-dimensional barcodes have become important marketing tools. Currently, the quick response (QR) code, which is a type of two-dimensional barcode, is used to record a web address. Typically, a user terminal, such as a smart phone, is used as a QR code scanner for scanning such QR code recorded with a web address, and converts it into the web address, thereby directing the user terminal to a specific web page which is located at the web address without the need for a user to type the web address manually into a web browser.

However, every QR code only records a single web address. As such, if a specific web page located at the single web address is damaged or has been removed, a broken link occurs. Therefore, it is necessary to find a solution for such broken link.

### SUMMARY OF THE INVENTION

Therefore, an object of the present invention is to provide a web page provision method and system that can overcome the aforesaid drawback of the prior art.

According to one aspect of the present invention, there is provided a web page provision method adapted to be implemented by a system. The system includes a server, and a first user terminal establishing a link with the server. The server includes a web page generation module, a web address generation module, a web address alias generation module, a two-dimensional barcode generation module, and a storage unit. The web page provision method of this invention comprises the steps of:

a) generating, by the web page generation module of the server, based on service data transmitted from the first user terminal and stored in the storage unit, a service web page corresponding to the service data, and generating, by the web address generation module of the server, a web address at which the service web page is located;

b) in response to a barcode generation request transmitted from the first user terminal, generating, by the web address alias generation module of the server, a web address alias based on the web address generated in step a) and on at least one alternative web address at which a specific web page is located;

c) generating, by the two-dimensional barcode generation module of the server, a two-dimensional barcode corresponding to the web address alias based on the web address alias generated in step b).

According to another aspect of the present invention, a web page provision system comprises a server receiving service data and a barcode generation request associated with the service data. The server includes a storage unit, a web page generation module, a web address generation module, web address alias generation module, a web address alias generation module and a two-dimensional barcode generation module. The storage unit stores the service data transmitted from the first user terminal. The web page generation module generates a service web page based on the service data. A web address generation module generates a web address of the service web page. The web address alias generation module generates, in response to the barcode generation request transmitted from the first user terminal, a web address alias based on the web address generated by the web address generation module, and on at least one alternative web address at which a specific web page is located. The two-dimensional barcode generation module generates, based on the web address alias generated by the web address alias generation module, a two-dimensional barcode corresponding to the web address alias.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram illustrating a system suitable for use in implementing the preferred embodiment of a web page provision method according to the present invention;

FIG. 2 is a flow chart illustrating the process of the web page provision method of the preferred embodiment;

FIG. 3 is a flow chart illustrating an exemplary operation of step S26 in accordance with the web page provision method of the preferred embodiment; and

FIG. 4 is a flow chart illustrating another exemplary operation of step S26 in accordance with the web page provision method of the preferred embodiment.

### DETAILED DESCRIPTION OF THE PREFERRED EMBODIMENT

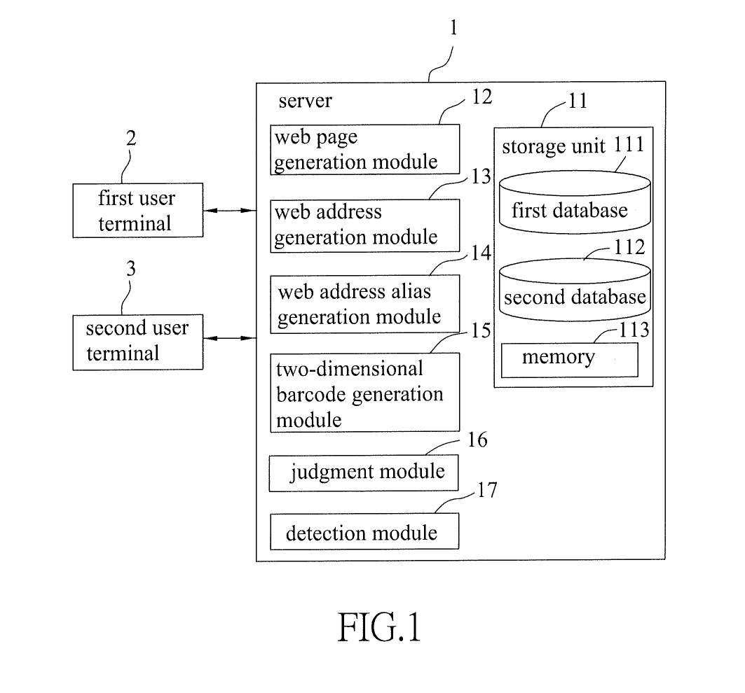

FIG. 1 illustrates a system suitable for use in implementing the preferred embodiment of a web page provision method according to the present invention. In this embodiment, the system includes a server 1, a first user terminal 2 and a second user terminal 3. In other embodiments, the system can include a plurality of the first user terminals 2 and a plurality of the second user terminals 3. The first user terminal 2 is a personal computer, a flat panel computer or a smart phone. The first user terminal 2 establishes a link with the server 1. The second user terminal 3 is a flat panel computer or a smart phone, and has an operating system. The sever 1 includes a storage unit 11, a web page generation module 12, a web address generation module 13, a web address alias generation module 14, a two-dimensional barcode generation module 15, a judgment module 16, and a detection module 17.

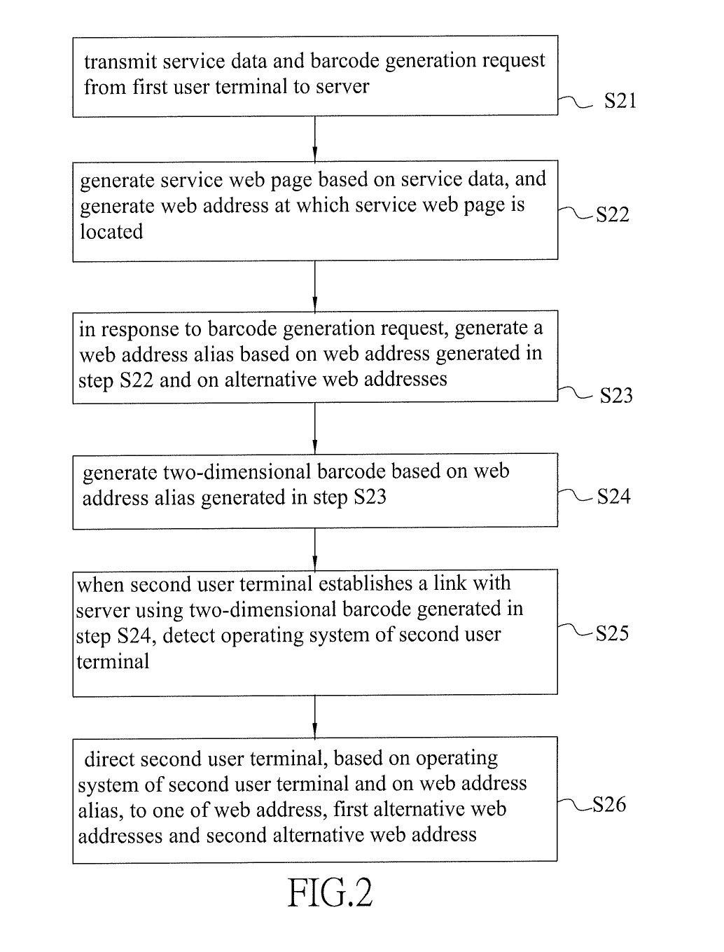

Referring to FIG. 2, there is shown a flow chart to illustrate how the system performs the web page provision method of the preferred embodiment.

First, the first user terminal 1 transmits, to the server 1, service data and a barcode generation request associated with the service data (step S21). In this embodiment, the service data received by the server 1 is stored in a first database 111 of the storage unit 11.

Then, the web page generation module 12 of the server 1 generates, based on the service data stored in the first database 111 of the storage unit 11, a service web page corresponding to the service data (step S22). The web address generation module 13 of the server 1 generates a web address at which the service web page is located.

Next, in response to the barcode generation request from the first user terminal 2, the web address alias generation module 14 generates a web address alias based on the web address generated in step S22 and on a plurality of alternative web addresses at each of which a specific web page is located (step S23). In this embodiment, the alternative web addresses include a number of first alternative web addresses, and a second alternative web address. The first alternative web addresses are contained in the service data from the first user terminal 2, and are respectively available for different operating systems, such as Android, iOS, Windows, etc. It is noted that the specific web page located at each first alternative web address is a web page that is associated with the service data and that is suitable to be displayed in the respective operating system. The second alternative web address is pre-stored in a memory 113 of the storage unit 11. The specific web page located at the second alternative web address is a homepage provided by the server 1.

Thereafter, the two-dimensional barcode generation module 15 of the server 1 generates, based on the web address alias generated in step S23, a two-dimensional barcode corresponding to the web address alias (step S24).

It is noted that a second database 112 of the storage unit 1 stores the web address generated by the web address generation module 13 in step S22, the first alternative web addresses contained in the service data, the second alternative web address, the web address alias generated by the web address alias generation module 14 in step S23, the two-dimensional barcode generated by the two-dimensional barcode generation module 15 in step S24, and location data associated with the web address alias and corresponding to the service data stored in the first database 111. In this embodiment, the location data is, but not limited to, a primary key value of the service data. In addition, the second user terminal 3 is capable of establishing a link with the server 1 using the two-dimensional barcode generated in the step S24.

When the second user terminal 3 establishes a link with the server 1 using the two-dimensional barcode, the detection module 17 of the server 1 detects the operating system of the second user terminal 3 (step S25).

Then, the judgment module 16 of the server 1 directs, based on the web address alias corresponding to the two-dimensional barcode, and on the operating system of the second user terminal 3, the second user terminal 3 to one of the web address, the first alternative web addresses and the second alternative web address such that a corresponding one of the service web page and the specific web pages is linked to and displayed on the second user terminal 3 (step S26). As a result, one of the service web page and the specific web pages is provided to the second user terminal 3.

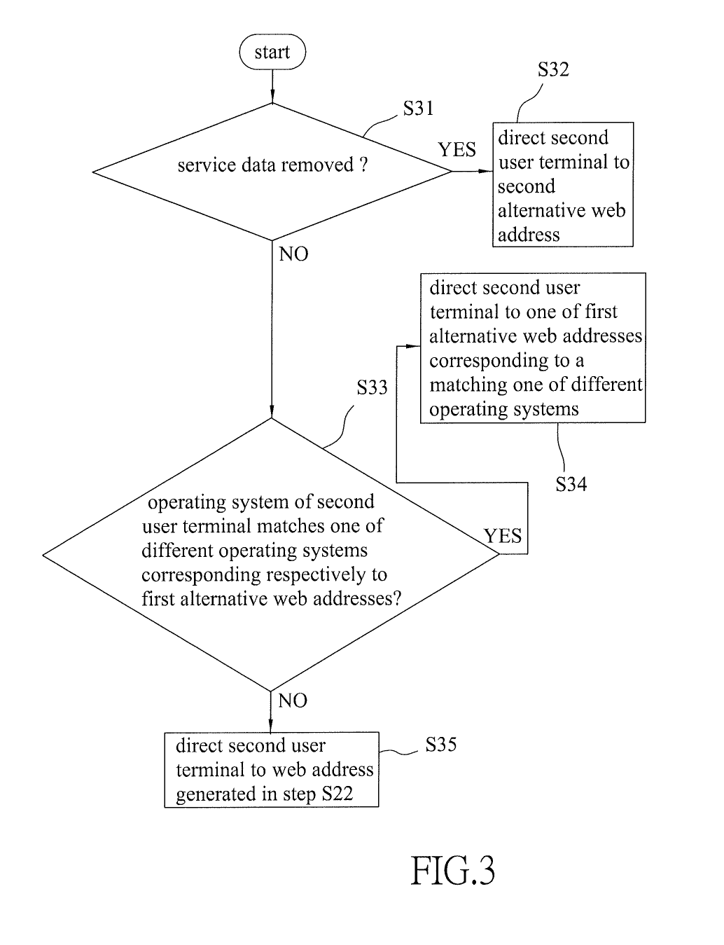

FIG. 3 is a flow chart of an exemplary operation of step S26 performed by the judgment module 16 of the server 1 in accordance with the web page provision method of the preferred embodiment. In this example, the service data from the first user terminal 2 includes basic personal data associated with an individual person. The basic personal data includes, but is not limited to, name, occupation, duties, work units, telephone number, e-mail address and other contact information of the individual person. Thus, the service web page generated by the web page generation module 12 of the server 1 in step S22 of FIG. 2 is in the form of a personal web page containing the basic personal data. In addition, the specific web page located at each first alternative web address is a web page associated with a corporation to which the individual person belongs.

In step S31, the judgment module 16 determines, based on the location data stored in the second database 112 of the storage unit 11, whether the service data has been removed from the first database 111 of the storage unit 11. If the result is affirmative, the flow goes to step S32. Otherwise, the flow proceeds to step S33.

In step S32, the second user terminal 3 is directed to the second alternative web address such that the homepage provided by the server 1 is linked to and displayed on the second user terminal 3. That is to say, the homepage provided by the server 1 is provided to the second user terminal 3.

In step S33, the judgment module 16 verifies, based on the web address alias corresponding to the two-dimensional barcode, which is used by the second user terminal 3, whether the operating system of the second user terminal 3 detected by the detection module 17 in step S25 of FIG. 2 matches one of the different operating systems corresponding respectively to the first alternative web addresses. If there is a match, the flow goes to step S34. Otherwise, the flow proceeds to step S35.

In step S34, the second user terminal 3 is directed to one of the first alternative web addresses corresponding to a matching one of the different operating systems such that the specific web page located at said one of the first alternative web addresses is linked to and displayed on the second user terminal 3. That is to say, the specific web page located at said one of the first alternative web addresses is provided to the second user terminal 3.

In step S35, the second user terminal 3 is directed to the web address generated by the web address generation module 13 in step S22 of FIG. 2 such that the service web page generated by the web page generation module 12 in step S22 of FIG. 2 is linked to and displayed on the second user terminal 3. That is to say, the service web page is provided to the second user terminal 3.

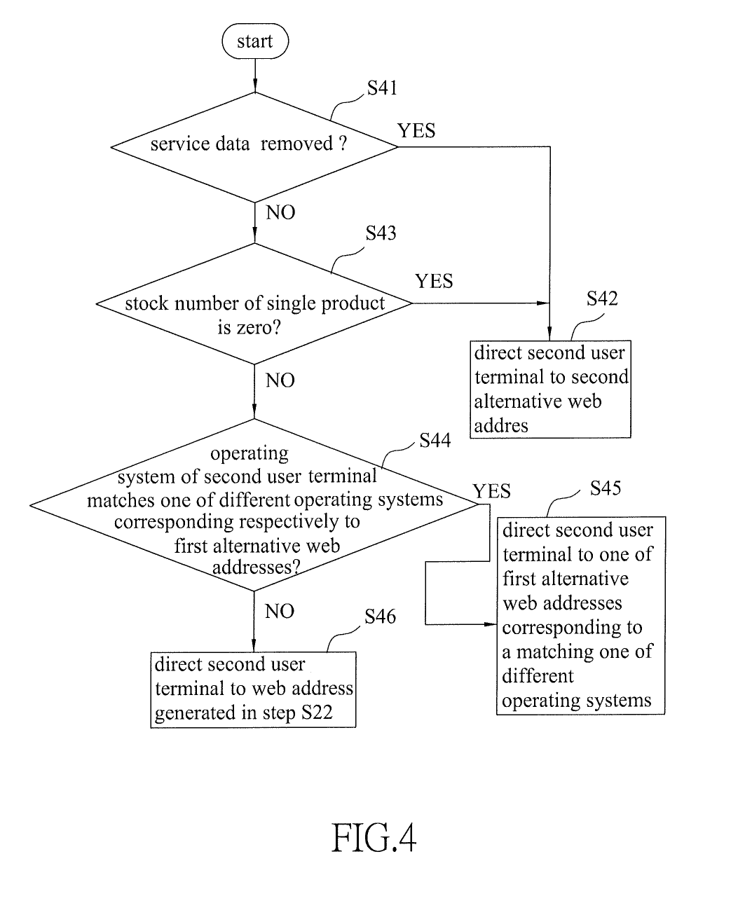

FIG. 4 is a flow chart of another exemplary operation of step S26 performed by the judgment module 16 of the server 1 in accordance with the web page provision method of the preferred embodiment. In this example, the service data includes product data related to a single product to be sold. The product data includes, but is not limited to, name, price and stock number of the single product. As a result, the service web page generated by the web page generation module 12 in step S22 of FIG. 2 is in the form of a shopping web page containing the product data. In addition, the specific web page located at each first alternative web address is another shopping web page associated with the single product.

In step S41, similar to step S31 of FIG. 3, the judgment module 16 determines, based on the location data stored in the second database 112 of the storage unit 11, whether the service data has been removed from the first database 111 of the storage unit 11. If the result is affirmative, the flow goes to step S42. Otherwise, the flow proceeds to step S43.

In step S42, the second user terminal 3 is directed to the second alternative web address such that the homepage provided by the server 1 is linked to and displayed on the second user terminal 3. That is to say, the homepage provided by the server 1 is provided to the second user terminal 3.

In step S43, the judgment module 16 determines, based on the service data, whether a stock number of the single product is zero. If the result is affirmative, the flow goes to step S42. Otherwise, the flow proceeds to step S44.

In step S44, similar to step S33 of FIG. 3, the judgment module 16 verifies, based on the web address alias corresponding to the two-dimensional barcode, which is used by the second user terminal 3, whether the operating system of the second user terminal 3 detected by the detection module 17 in step S25 of FIG. 2 matches one of the different operating systems corresponding respectively to the first alternative web addresses. If there is a match, the flow goes to step S45. Otherwise, the flow proceeds to step S46.

In step S45, similar to step S34 of FIG. 3, the second user terminal 3 is directed to one of the first alternative web addresses corresponding to a matching one of the different operating systems such that the specific web page located at said one of the first alternative web addresses is linked to and displayed on the second user terminal 3. That is to say, the specific web page located at said one of the first alternative web addresses is provided to the second user terminal 3.

In step S46, similar to step S35 of FIG. 3, the second user terminal 3 is directed to the web address generated by the web address generation module 13 in step S22 of FIG. 2 such that the service web page generated by the web page generation module 12 in step S22 is linked to and displayed on the second user terminal 3. That is to say, the service web page is provided to the second user terminal 3.

In view of the above, upon establishing a link between the second user terminal 3 and the server 1 using the two-dimensional barcode generated by the server 1, the web page provision method of this invention can effectively provide an available web page to the second user terminal 3 by directing the second user terminal 3 to an appropriate one of the web address generated by the web address generation module 13, the first alternative web addresses and the second alternative web address even if the service data has been removed from the first database 111 of the storage unit 11, thereby preventing a broken link encountered in the prior art

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A web page provision method adapted to be implemented by a system that includes a server and a first user terminal establishing a link with the server, the server including a web page generation module, a web address generation module, a web address alias generation module, a two-dimensional barcode generation module and a storage unit, said web page provision method comprising the steps of:
a) generating, by the web page generation module of the server, based on service data transmitted from the first user terminal and stored in the storage unit, a service web page corresponding to the service data, and generating, by the web address generation module of the server, a web address at which the service web page is located;
b) in response to a barcode generation request transmitted from the first user terminal and associated with the service data, generating, by the web address alias generation module of the server, a web address alias based on the web address generated in step a) and on at least one alternative web address at which a specific web page is located;
c) generating, by the two-dimensional barcode generation module of the server, a two-dimensional barcode corresponding to the web address alias based on the web address alias generated in step b).

2. The web page provision method as claimed in claim 1, wherein, in step c), the two-dimensional barcode is a quick response (QR) code.

3. The web page provision method as claimed in claim 1, wherein, in step b), the alternative web address is contained in the service data or is pre-stored in the storage unit of the server.

4. The web page provision method as claimed in claim 3, wherein, in step b):
when the alternative web address is contained in the service data, the specific web page includes a web page associated with the service data; and
when the alternative web address is pre-stored in the storage unit of the server, the specific web page includes a homepage provided by the server.

5. The web page provision method as claimed in claim 1, the system further including a second user terminal capable of establishing a link with the server by using the two-dimensional barcode generated in step c), the server further including a judgment module, said web page provision method further comprising the step of:
d) when the second user terminal establishes a link with the server by using the two-dimensional barcode generated in step c), directing the second user terminal, by the judgment module of the server, based on the web address alias corresponding to the two-dimensional barcode, to one of the web address and the alternative web address such that a corresponding one of the service web page and the specific web page is linked to and displayed on the second user terminal.

6. The web page provision method as claimed in claim 5, wherein, in step d), the judgment module of the server directs the second user terminal to the alternative web address upon detecting that the service data has been removed from the storage unit of the server.

7. The web page provision method as claimed in claim 5, wherein:
the service data includes basic personal data; and
the service web page generated in step a) is in the form of a personal web page containing the basic personal data.

8. The web page provision method as claimed in claim 5, wherein:
the service data includes product data related to a single product to be sold; and
the service web page generated in step a) is in the form of a shopping web page containing the product data.

9. The web page provision method as claimed in claim 8, wherein:
the product data includes a stock number of the single product; and
in step d), the judgment module of the server directs the second user terminal to the alternative web address upon detecting that the stock number of the single product is zero.

10. A web page provision system comprising:
a server receiving service data and a barcode generation request associated with the service data, said server including
a storage unit for storing the service data,
a web page generation module for generating a service web page based on the service data,
a web address generation module for generating a web address of the service web page,
a web address alias generation module for generating, in response to the barcode generation request transmitted from said first user terminal, a web address alias based on the web address generated by said web address generation module, and on at least one alternative web address at which a specific web page is located, and
a two-dimensional barcode generation module for generating, based on the web address alias generated by the web address alias generation module, a two-dimensional barcode corresponding to the web address alias.

11. The web page provision system as claimed in claim 10, wherein the two-dimensional barcode is a quick response (QR) code.

12. The web page provision system as claimed in claim 10, wherein the alternative web address is contained in the service data or is pre-stored in said storage unit of said server.

13. The web page provision system as claimed in claim 12, wherein:
when the alternative web address is contained in the service data, the specific web page includes a web page associated with the service data; and
when the alternative web address is pre-stored in said storage unit, the specific web page includes a homepage provided by said server.

14. The web page provision system as claimed in claim 10, further comprising a first user terminal establishing a link with said server for transmitting thereto the service data and the barcode generation request.

15. The web page provision system as claimed in claim 10, further comprising a second user terminal capable of establishing a link with said server by using the two-dimensional barcode;
wherein said server further includes a judgment module for directing said second user terminal, based on the web address alias corresponding to the two-dimensional barcode, to one of the web address and the alternative web address when said second user terminal establishes a link with said server by using the two-dimensional barcode, such that a corresponding one of the service web page and the specific web page is linked to and displayed on the second user terminal.

16. The web page provision system as claimed in claim 15, wherein said judgment module of said server directs the second user terminal to the alternative web address upon detecting that the service data has been removed from said storage unit of said server.

17. The web page provision system as claimed in claim 15, wherein:
the service data includes basic personal data; and
the service web page generated by said web page generation module of said server is in the form of a personal web page containing the basic personal data.

18. The web page provision system as claimed in claim 15, wherein:
the service data includes product data related to a single product to be sold; and
the service web page generated by said web page generation module of the server is in the form of a shopping web page containing the product data.

19. The web page provision system as claimed in claim 18, wherein:
the product data includes a stock number of the single product; and
said judgment module of said server directs said second user terminal to the alternative web address upon detecting that the stock number of the single product is zero.
